(19) United States
(12) Patent Application Publication
(10) Pub. No.: US 2008/0254081 A1
(43) Pub. Date: Oct. 16, 2008

(54) Moist Wipe and Method of Making Same

(75) Inventors: Gary L. Schroeder, Neenah, WI (US); T. Philips Oriaran, Appleton, WI (US); Edward J. Yock, Appleton, WI (US); Bradley G. Schmidt, Green Bay, WI (US); Michael E. Huss, Neenah, WI (US); Henry S. Ostrowski, Omro, WI (US)

Correspondence Address: PATENT GROUP GA030-43;GEORGIA-PACIFIC LLC, 133 PEACHTREE STREET, N.E., ATLANTA, GA, 30303-1847, US

(73) Assignee: GEORGIA-PACIFIC CONSUMER PRODUCTS LP, Atlanta, GA (US)

(21) Appl. No.: 12/139,582

(22) Filed: Jun. 16, 2008

Related U.S. Application Data
(63) Continuation of application No. 11/381,364, filed on May 3, 2006, now abandoned.
Application No. 11/381,364 is a division of application No. 10/051,814, filed on Jan. 14, 2002, now abandoned.

(51) Int. Cl. A01N 33/12; A01N 25/34; A01P 1/00

(52) U.S. Cl. 424/404; 514/643

(57) ABSTRACT

A moist wipe having a web of fibers stabilized as with a suitable binder, and the stabilized, dry web having an anionic surface charge not greater than about 1.2 meq/Kg. A cationic functional agent in an aqueous imbuement is added to the web which is partially adsorbed by the web and a portion of the agent remaining free. Because the anionic surface charge on the substrate is relatively low, there remains in the free aqueous medium a sufficient quantity of the functional agent deliverable to the surface to achieve the desired efficacy. The resulting web will adsorb a limited amount of the cationic functional agent in the aqueous imbuement, and thereby an adequate amount of the agent remains in the solution free of the web for deliverance to the surface, thereby obviating high loadings of the imbuement and the active functional agent.

### CROSS REFERENCE TO RELATED APPLICATION

This application is a continuation of U.S. application Ser. No. 11/381,364 filed May 3, 2006, which is a division of application Ser. No. 10/051,814, filed Jan. 14, 2002. The priorities of the foregoing applications are hereby claimed and the entirety of their disclosures incorporated herein by reference.

### FIELD OF THE INVENTION

This invention relates to a moist wipe, often referred to somewhat misleadingly as a “wet wipe.” In a more specific aspect, this invention relates to a moist wipe capable of more efficiently delivering a cationic functional agent carried in the imbuement of the moist wipe. Another aspect of the invention includes the method for making the moist wipe.

### BACKGROUND OF THE INVENTION AND PRIOR ART

Moist wipes typically comprise a substrate and an aqueous imbuement carrying one or more functional ingredients. Although moist wipes are more commonly referred to as “wet wipes,” in most applications it is desired that the amount of imbuement carried by the “wet wipe” for delivery be limited such that the “wet wipe” is not truly wet but rather is moist so that undesirable dripping of the imbuement is easily avoided and the imbuement therefore applied in a controllable manner. The substrates are typically soft, absorbent, flexible and porous comprising fibers which are hydrophilic or can be rendered hydrophilic. In most applications, primarily for reasons of cost, the substrate is a nonwoven fabric, typically produced by known nonwoven forming technologies including, for example, dry forming or airlaid forming. The functional ingredients can be antimicrobial agents, softeners, antistatic agents, or mixtures thereof. Antimicrobial agents in particular are often highly cationic, comprising such materials as benzalkonium chloride, benzethonium chloride and mixtures thereof. We have found that in many cases, particularly where the functional ingredients comprise cationic species, an interaction between the substrate and the cationic species in the imbuement greatly reduces the effectiveness of the cationic functional ingredient.

Generally, when nonwoven fabrics such as are typically used for the substrates of moist wipes are formed using dry forming or airlaid systems, fibers which may be cellulosic, synthetic or a combination of the two are suspended in a gaseous stream, as for example, air, and conveyed to a forming screen upon which a nascent web of relatively randomly oriented fibers is formed. The nascent web lacks integrity and therefore must be consolidated or stabilized. For the formation of substrates for moist wipes, the nascent web is typically consolidated by thermal or chemical means. Where the nascent web comprises a significant proportion of synthetic fibers, particularly so-called bicomponent fibers, thermal consolidation is often used. Where the nascent web comprises primarily cellulosic fibers, consolidation is normally effected by chemical means involving application of a binder to the nascent web. Typically the binder will be an aqueous mixture of at least a polymer and a surfactant, which is applied to one or both sides of the web and serves to cause the fibers to adhere to each other where they are in contact without unduly stiffening the web or unduly diminishing its absorbency. It should be understood that a mixture or a polymer and a surfactant is generally referred to as a latex. The cellulosic fibers used in forming substrates typically used in moist wipes have a substantial anionic character. Further, the surfactants included in the binder used to consolidate the nascent web are often anionic. We have found that when the cationic functional ingredient is included in the imbuement, an undesirable interaction between the cationic functional ingredient and the substrate greatly reduces the amount of the cationic functional ingredient which is retained in the imbuement and is available for its desired action. A moist wipe made of a nonwoven fabric in accordance with the prior art using benzalkonium chloride in the imbuement and most typically an anionic surfactant in the latex shows that typically only about 10 percent of the cationic functional ingredient is actually available for its desired purpose, the remainder being rendered ineffective by interaction with the substrate. In many of the products known to the prior art, this effect can be compensated for merely by greatly increasing either the amount of imbuement or the amount of the cationic functional ingredient in the imbuement far above that actually needed for the desired purpose. While this technique is practicable in some applications, because many of the cationic functional ingredients are relatively expensive, it is a far from an optimum solution. Further, in many cases, the desired efficacy would require amounts of imbuement ranging up to perhaps four times the dry weight of the substrate leading to dripping or difficulty in controlling the disposition of the imbuement thereby impeding the desired use of the moist wipe and thus may be considered impractical.

It is common, however, that because of the disadvantages mentioned above, the amount of functional agent in liquid or aqueous form delivered to the surface is insufficient to be effective or satisfactory. In order to provide a moist wipe capable of delivering an effective amount of the functional agent to the surface, a large excess of the functional agent is required, that is, the concentration of the functional agent is high, or the wipe is provided with a large excess of the liquid containing the functional agent. Thus, it is known in the prior art that in order to provide for an adequate amount of functional agent deliverable to the surface, not only is the concentration of the functional agent high, but the total amount of liquid containing the functional agent required is typically about three to four times the weight of the substrate. As stated above, a high percentage of liquid containing the functional agent is adsorbed by the substrate, which problem is aggravated by the excess of liquid thereby resulting in a waste of the functional agent and other components of the liquid.

The prior art discloses wipes having incorporated therein differing combinations of materials depending upon the desired end product. For example, there is shown in U.S. Pat. No. 6,103,060 a paper or non-woven web formed by suspending the fibers in a foaming liquid containing a non-ionic surfactant in order to optimize such properties as softness, dry strength, and wet strength. A cationic additive may be used if it is not reactive with the surfactant. However, this patent does not disclose a moist wipe for delivering a functional agent to a surface. A wet wipe is disclosed in U.S. Pat. No. 5,141,803, which is impregnated with an aqueous composition consisting of a preservative, a non-ionic surfactant, and one of two polymeric cationic biocides, and is deliverable to a surface. The loading of the aqueous composition is from two to five times the weight of the substrate, which is considered excessive, therefore prohibitive, and results in a loss of materials, especially the biocide. In fact, it is a decided disadvantage and a common shortcoming of the prior art to use high loadings of the functional agent in order to have a wet wipe that can deliver an effective amount to the surface.

It has been demonstrated that with four commercially available wipes using bonded nonwoven webs, two with latex bonded carded webs and two with thermal bonded carded webs, excessive quantities of the functional agent are required. These moist wipes were analyzed to determine the amount of cationic antibacterial agent in solution in the imbuement squeezed from the wipes. The wipes were rinsed thoroughly with deionized water, dried, and analyzed to determine the anionic surface charge of the wipes. The methods detailed in the examples set forth below were used to quantify the cationic antibacterial agent and the anionic surface charge. The results are summarized in the table below.

TABLE I
Competitive Wet Wipes Containing Cationic Antibacterial Agents

| | | Milli- | | | | |
|---|---|---|---|---|---|---|
| | | equivalents | | | | |
| Product Code | | per liter | | Ratio in | Anionic | |
| (Thermal or | Name of | (or mM) | Weight | Solution | Surface | Ratio of |
| Latex Bonded | Cationic | Initial | Percent | per | Charge | g Imbuement |
| Web) | Additive(s) | Conc. | Initial | Initial | (meq/Kg) | g Dry Wipes |
| A | Benzalkonium | 8.1 | 0.28 | 1.0 | 2.00 | 3.61 |
| (Thermal | Chloride | | | | | |
| Bonded Web) | | | | | | |
| B | Benzalkonium | 7.9 (total) | 0.145 + 0.145 | >0.38* | 1.67 | 3.53 |
| (Thermal | Chloride + | | | | | |
| Bonded Web) | Ethyl | | | | | |
| | Benzalkonium | | | | | |
| | Chloride | | | | | |
| C | Benzethonium | 6.7 | 0.30 | 0.59 | 1.84 | 3.31 |
| (Latex Bonded | Chloride | | | | | |
| Web) | | | | | | |
| D | Benzalkonium | 4.8 | 0.17 | 0.58 | 2.40 | 3.92 |
| (Latex Bonded | Chloride | | | | | |
| Web) | | | | | | |

*The analysis method used to quantify benzalkonium chloride does not include several peaks for the ethyl benzalkonium chloride. Therefore, this ratio would be higher were the method corrected to include all of the ethyl benzalkonium chloride.

It should be noted from the data in this table that all of these samples have a high anionic surface charge for the dried wipes. Samples A, B, and C all add the cationic active agent(s) at significantly high concentration levels along with adding the imbuement at significantly high levels. Although sample D uses a reasonable concentration of cationic active agent, which we found to be useful, the product adds 30 percent more weight of imbuement per weight of dry wipe. These excess imbuement levels (and concentration levels for samples A, B, and C) mean that these products use enough cationic active agent to overwhelm the anionic surface charge.

In many cases, it is not practical to use an excess of cationic functional ingredient, particularly in cases where the total concentration or amount of cationic functional ingredient that may be added to the product is strictly limited either by considerations of cost or compliance with regulations.

It is therefore an object of the present invention to provide moist wipes in which cationic functional ingredients may be delivered with improved efficiency while avoiding undesirable dripping of the imbuement.

Another object of the invention is to provide a moist wipe capable of delivering an effective amount of an aqueous cationic functional agent to a surface.

It is another object of the invention to provide a moist wipe that obviates the need for excessive loadings of the medium containing the functional agent.

It is still another object of the invention to provide a moist wipe of the above type that utilizes cellulosic fibers alone or in combination with synthetic fibers.

### SUMMARY OF THE INVENTION

The moist wipes of the present invention comprise a bonded nonwoven substrate and a liquid imbuement carrying at least one cationic functional ingredient wherein the surface charge of the substrate is controlled to range from cationic in character to not greater than about 1.2 meq of anionic sites per Kg of dry web.

The moist wipe comprises a bonded nonwoven web or fabric which should be understood to include wipes manufactured by any of the several processes for manufacture of such sheet material including airlaid forming, wet laying, bonded carding, and thermal bonding. The substrate comprises cellulosic fibers or mixtures or blends of cellulosic fibers with polymeric or synthetic fibers. Preferably, the web is essentially aldehyde free, because formaldehyde in particular is a common irritant. Even in the case in which the surface charge of the substrate is controlled as discussed above, a considerable portion of the cationic functional ingredient in the imbuement will be rendered unavailable by interaction with the substrate; but the amount of cationic functional ingredient remaining available in the imbuement will be considerably increased above that of the products known to the prior art. Accordingly, because the anionic sites present on the substrates used in the present invention are limited, a sufficient quantity of the cationic functional ingredient remains available in the imbuement to be delivered to the desired surface to achieve the desired efficacy. Thus, when the end-user or consumer removes a wipe from the package, the amount of cationic functional ingredient may be delivered to the surface in a sufficient quantity for the desired efficacy while the tendency of the moist wipe to drip will be controlled aiding the consumer and limiting application of imbuement to the desired portion of the surface.

In accordance with one embodiment of the present invention, the web is a bonded nonwoven web stabilized by thermal bonding or with a suitable binder comprising a polymer and a surfactant chosen from the group consisting of non-ionic surfactants, cationic surfactants, and mixtures thereof. Many of the commercially available binders contain small but undesirable amounts of aldehydic components. We prefer to use binders that are substantially aldehyde free to form a stabilized web having surface charge characteristics ranging from cationic through neutral up to about 1.2 meq of anionic sites per Kg of dry web as measured by the procedure detailed herein below. Preferably, the web has substantially neutral surface charge characteristics. In this manner, ionic incompatibility between the substrate and the cationic functional ingredient in the imbuement can be substantially reduced, as the resulting web will adsorb only a limited amount of the cationic functional ingredient in the imbuement and therefore an adequate amount of the cationic functional ingredient remains in the imbuement for delivery to the surface. As a consequence, the need for high loadings of imbuement and cationic functional ingredient is substantially eliminated.

In manufacture of the moist wipe, the substrate is first formed by conventional dry laid process, preferably the airlaid process. A conventional air forming system includes two or more heads, through which fibers are conveyed while carried by a gaseous stream and are distributed on a forming screen, whereby plies of fibers are condensed on the screen as the nascent web. The fibers used in the manufacture of the structure may be cellulosic, modified cellulosic, synthetic or a combination of the foregoing fibers. Such fibers include, for example, wood pulp fibers, rayon, polyesters, polyethylene, polypropylene, and combinations thereof. When such fibers are dry laid, the degree of mechanical entanglement is not usually sufficient to provide good integrity to the structure. A binder or latex of an aqueous emulsion with polymeric material and a surfactant is applied to one or both surfaces of the web to impregnate the web and, upon curing, stabilized this substrate or structure. In the manufacturing operation of the substrate used in the present invention, the components are selected, particularly the binder, so that the resulting structure has anionic charge ranging from cationic through neutral to no more than 1.2 meq of anionic sites per Kg of dry web. The substrate is imbued with an aqueous base medium comprising a cationic functional agent and where desired other ingredients, and the resulting wipe is packaged for distribution and use. By reason of our invention, a reduced portion of the cationic functional ingredient is adsorbed by the substrate resulting in an increased effective portion remaining in the solution for delivery, thereby diminishing the expected need for high loadings of the active ingredient in the imbuement.

### BRIEF DESCRIPTION OF THE DRAWINGS

The invention and its advantages will be more readily understood by reference to the following detailed description and exemplary embodiments when read in conjunction with the following drawings, wherein:

FIGS. 1A, 1B, and 1C are a schematic representation illustrating the effect of loadings and the transport or deliverance of the cationic functional agent.

FIGS. 2A, 2B, and 2C are schematic flow diagrams of a process for making a wet wipe in accordance with the present invention.

### DETAILED DESCRIPTION OF THE INVENTION

In accordance with the present invention, there is provided a moist wipe capable of delivering an efficacious amount of a cationic functional agent or ingredient in an aqueous imbuement to a surface, whether animate or inanimate. By reason of our invention, we obviate the need for high loadings of the cationic functional ingredient, or for excessive quantities of the imbuement in order to deliver an efficacious amount of the agent. The moist wipe is produced generally in accordance with conventional manufacturing procedures for the production of such products except the materials are chosen to provide a substrate having the desired anionic surface charge characteristics so the process results in a moist wipe having unique and unexpected properties.

A substrate or web, comprising cellulosic fibers or a mixture of cellulosic and synthetic fibers or filaments, is produced by generally conventional methods of operation, as described below in detail. In the manufacturing process, the fibers or filaments, are condensed on a continuous forming screen. In a dry laid operation, forming substrates suitable for the present invention for example, a latex binder or admixture comprising a polymer and a surfactant chosen from the group consisting of cationic surfactants, non-ionic surfactants, and mixtures thereof is applied to the nascent web in order to stabilize the web, and the web subsequently dried. The components, including the fibers and binder are selected such that the dry web has surface charge characteristics ranging from cationic through neutral to no more than 1.2 meq of anionic sites per Kg of dry web as measured by the procedure detailed below. It should be understood that throughout this specification and claims, all surface charge measurements specified were obtained using the specified procedure. The constituent wood pulp fibers used to manufacture the nascent web will often exhibit substantial anionic surface charge, which may be in excess of that specified above. The anionic surface charge of the nascent web can vary depending on such factors as the type of wood in the pulp, the pulping bleaching process used, the type of cellulosic and/or re-generated cellulosic fibers used, or the particular combination of cellulosic and synthetic fibers chosen. Also the presence of wood pulp fines can impart a significantly higher surface charge than long fibers. However we find that in many cases the consolidated web will exhibit an anionic surface charge considerably reduced from the charge on the constituent fibers. Therefore, the combination of furnish and binder is selected to compensate for the surface charge on the fibers so that the form dry web has a surface charge within the specified range. The surfactant in the binder should be non-ionic, cationic or a mixture of the two in order to produce a web having the desired surface charge of not greater than about 1.2 milli-equivalents per kilogram, dry weight.

The binder is applied as an aqueous emulsion and/or dispersion, typically containing about 45 to 65 percent solids. Such materials are readily available. Because these latex emulsions are water miscible, they may be diluted further if desired, before being applied to the web. Binders available are classified by chemical family, and those particularly useful include vinyl acetate and acrylic ester copolymers, ethylene vinyl acetate copolymers, polyacrylates, styrene butadiene copolymers, and polyacrylonitriles. As the binder compositions may be thermosettable, in order to effect the cross-linking, they typically contain suitable amounts of cross-linking agents which are well-known chemical agents for this purpose such as, for example, sodium bisulfate, phosphoric acid, ammonium chloride, and N-methylacrylamide. The amount of binder used in the structure should not be so high as to substantially impair the usefulness of the wipe by limiting its absorbency unduly or as to impart an undesirable stiffness to the web as to render it impractical. We have found that the amount of latex applied may range from about 5 percent to about 40 percent by weight of the dry web, preferably from about 15 to about 30 weight percent of the dry web.

The binder includes a surfactant typically in the amount ranging from about 0.1 to about 5 percent by weight of the latex solids. The surfactant is non-ionic, cationic or a mixture of the two so that, when admixed with the latex, the anionic surface charge of the dry web containing the latex ranges from cationic through neutral up to no more than about 1.2 meq/Kg of anionic sites per Kg of dry web. Suitable surfactants include, for example, ethoxylated alcohols, ethoxylated alkyl phenols, poly(ethylene glycol) alkyl esters, poly(propylene glycol) alkyl esters, and poly(ethylene glycol) poly(propylene glycol) copolymers.

The resulting web containing the binder is consolidated by drying and exhibits sufficient integrity to subsequently be slit and cut to size, imbued and packaged. The cationic functional ingredient is comprised within the imbuement. A portion of the cationic functional agent may be adsorbed by the web but a sufficient amount of the cationic functional ingredient remains available in the imbuement for delivery to a surface to achieve the desired effect. We have found that to provide an effective amount of cationic functional ingredient for delivery to a surface, a loading of the imbuement ranges from about one to about three times the dry weight of the web, but this amount can vary depending upon such factors as the type of substrate, in particular its void structure, and the composition of the imbuement. A moist wipe utilizing higher loadings of imbuement as in the neighborhood of five times the dry weight of the web can result in an undue waste of imbuement and make it difficult for the consumer to control the application of the imbuement to the desired surface area while avoiding undesirable dripping of imbuement on surfaces to which its application is not desired. Moreover, concentration of the cationic functional ingredient in the imbuement remains sufficient to obtain the desired efficacy when delivered to the surface. It will be observed, however, that because the dry web exhibits a very low anionic to neutral charge, the overall concentration of the cationic functional ingredient in the imbuement may be relatively low as compared to prior art wet wipes using similar agents.

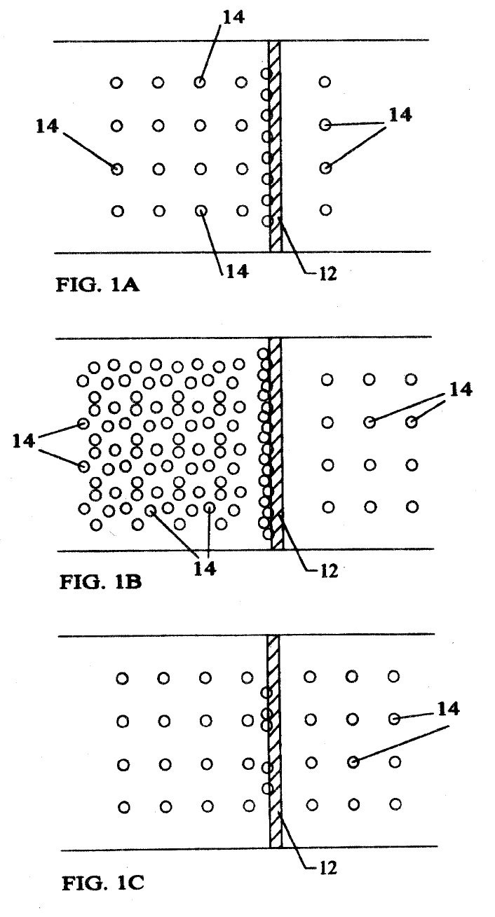

This discovery is conceptualized in FIGS. 1A, 1B, and 1C, which illustrates or perceptualizes the difference between lotions of the prior art and those lotions of the present invention. There is shown in FIG. 1A a receptacle 10 having on one side a transverse filter 12 representing the web of the prior art and having an ionic charge higher than 1.2 meq/Kg of dry web. The receptacle contains an aqueous solution or lotion having dissolved therein a cationic functional agent 14. It is known that if the concentration of the agent in the aqueous medium is low, a still lower concentration will be found in the effluent that permeates the filter, because a substantial percentage of cationic functional agent is retained by the filter. It should be understood that this illustration demonstrates the concept of lower adsorption of the cationic functional agent by a web exhibiting a lower anionic surface charge. The web in actuality is not a filter the imbuement must pass through. In order to increase the concentration of agent in the effluent, the concentration in the source must be increased, which is illustrated in FIG. 1B. However, in FIG. 1C, the solution contains the same low concentration of agent as that used in FIG. 1A, but filter 12 has an anionic charge no greater than 1.2 meq/Kg of dry web. As a consequence, a concentration of a substantially higher cationic functional agent is present in the effluent as compared to FIG. 1A. The filter 12 in this conceptualized schematic is considered as the functional equivalent of the web. It thus will be observed that the fabric or web does not bind as much cationic agent, and therefore relatively more of the cationic agent remains in the effluent of free solution. Hence, we have found that a concentration of about 6 milli-equivalents per liter or less of cationic functional agent in the imbuement, and a loading of one to three times the weight of the dry web, preferably two to three times, is adequate to deliver an effective amount of the cationic functional agent to the surface requiring treatment.

The cationic functional agent, preferably a cationic functional agent, is applied to the web in an aqueous medium or lotion. The agent can function, for example, as an antimicrobial agent, as an anti-static agent, or as softener. The cationic functional agent is selected depending upon the end use, and suitable agents can include, for example, dialkyl dimethyl ammonium chloride or dialkyl imidazolinium compounds for a softener, and dialkyl dimethyl ammonium salts or monoalkyl trimethyl ammonium salts for an anti-static wipe. Where desired, if the functional agent is not sufficiently soluble, up to about 20 percent by weight of the water may be replaced with a co-solvent in order to improve or increase the solubility of the ingredients in the imbuement, or to enhance surface treatment. Suitable co-solvents include, for example, ethanol, isopropanol, propylene glycol, glycerin, and poly(ethylene glycol). Suitable biocides or antimicrobial agents include, for example, benzalkonium chloride, benzethonium chloride, and dialkyl dimethyl ammonium chloride. The biocide can be used in a concentration ranging from about 0.1 to 6 milli-equivalents per liter, but this concentration can vary depending upon such factors as the specific biocide used, and the amount of lotion adsorbed by the web versus the amount remaining in the free liquid. Generally, as the concentration of the cationic functional agent is increased above 6 milli-equivalents per liter, the benefits decrease.

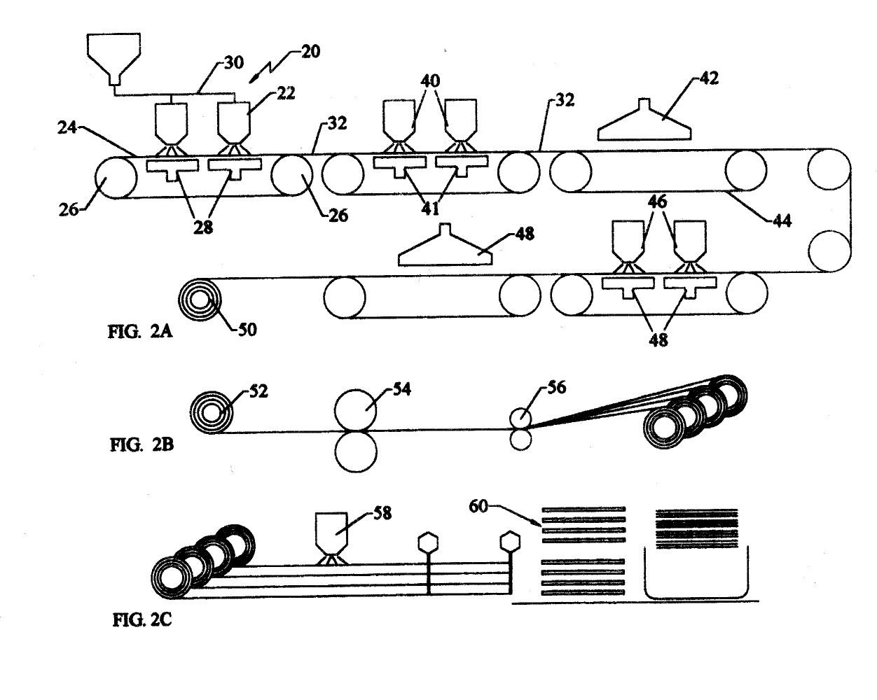

An embodiment for the manufacture of the moist wipe is shown in FIGS. 2A, 2B, and 2C. The substrate for the invention may be made using conventional equipment designed for dry laying or air forming systems, indicated generally by the numeral 20. A conventional system includes a distributor unit 22 disposed transversely above a continuous forming screen 24 mounted on rollers 26 and driven by a suitable motor (not shown), and vacuum means or suction box 28 is positioned beneath the screen. In a conventional air forming system, upstream of the distributor unit is a defibrator or feeder (not shown), such as a hammermill or Rando-Feeder, where bales, laps or the like are defiberized, and further the fibers may be cleaned and/or blended if necessary or desired depending largely on the type of fibers used, the blend of fibers used, and the end product sought. For example, wood pulp fibers can be blended with synthetic fibers and applied as a blend by the distributor, or each distributor can convey a different fiber to the screen to form separate plies or layers. The fibers are carried by an air stream via conduit 30 to the distributors. The porous forming screen 24 is essentially coextensive with the distributors, and the suction box 28 beneath the screen draws the air stream downwardly and conveys the fibers to the surface of the screen thereby forming plies of a loose web 32. At this stage in the process, the web exhibits little integrity, and the vacuum retains the loose, fibrous web on the screen. It should be understood that the system may be modified to control the composition and thickness of the end product. For example, the distributor unit typically comprises a plurality of individual distributors, and although the drawing shows schematically two distributors at 22, this number of distributors and particular arrangement can be altered or varied depending on such factors as machine speed, capacity, type of fibers, and end product desired.

At this stage of the process, the web 32 condensed on the forming screen 24 has very little integrity and requires stabilization. The web is advanced by the continuous screen, and where desired, the web first may be passed between compression rollers, which may be heated, to densify the web, but this step is optional. This densification step enhances the penetration of the binder into the web, and the degree or percent of densification can vary depending of such factors as the basis weight of the web, the desired degree of penetration of the binder into the web, and the end product sought. From there, the web is transported to a suitable dispensing means 40, such as a spray nozzle, doctor blade, roller applicator, or the like, where the binder containing a non-ionic or cationic surfactant is applied to the surface of the loose web. A vacuum applied by suction box 41 positioned beneath the dispensing means and screen helps to draw the latex into the web. The dispensing means or applicator is essentially coextensive with the width of the web, and preferably a substantially uniform coating is applied to the web surface. However, the binder may be applied as a nonuniform, random or pattern coating, and because the latex is water-based, it will diffuse throughout the web and function as a binder when cured. The binder when cured imparts integrity to the web, and therefore some penetration of the latex is required. The extent or degree of penetration of the binder into the web is controlled by controlling the amount of binder applied and by controlling the vacuum applied to the web in that the vacuum helps to draw the binder into the web. The binder is usually applied as an aqueous emulsion, and is a thermosetting plastic. In order to activate the binder, the latex emulsion contains a suitable curing agent or cross-linking agent, and the web is coated. The latex is cured to effect cross-linking. Most typically, curing is accomplished by passing the coated web through a hot air oven or through air drier 42, and the temperature typically ranges from about 200° F. to 500° F., but this depends upon the specific type of latex resin used, the curing agent or cross-linking agent, the amount of latex, the thickness of the web, the degree of vacuum, and the machine speed. It is desirable to coat both surfaces of the web with binder, and this readily accomplished by reverse rolling the web so that the top surface at the dispensing means 30 becomes the bottom surface. Thus, the web 32 is transferred to a second screen 44 and then advanced to a second dispensing means 46, including suction box 48, where a binder is now applied to the opposite side. This second latex coating is likewise cured by passing the web through a second oven 48 with about the same temperature range.

The formed web is typically taken up on a roller 50, and subsequently transferred to a roll unwinder 52 for further processing. However, for quality control, at about this stage of the process a sample of the web is cut from the roll and measured for anionic surface charge. A measurement for the charge is determined by the procedure described below.

The roll of formed web, assuming it passes quality control, is transferred to an unwind roll 52. The web may be passed through an embossing roller 54, which operation is optional, to impart a pattern to the web and to improve the bulk. The web is then slit to the desired width at slitter 56, and then passed through or under a spray mechanism 58 to wet the web with the lotion containing the cationic functional agent. The wet webs are hermetically packaged at station 60 either individually in a single packet or stacked in a multiple arrangement and placed in a suitable canister. For a dry web useful as a moist wipe for this invention, the airlaid web should have a basis weight of about 30 to 60 pounds per square foot, a cross direction wet tensile of at least about 300 grams per three inches, and an absorbency capacity of three grams per gram or greater.

The anionic surface charge was measured for each airlaid fabric. Portions of each sample (listed weight in grams) were weighed to the nearest 0.1 mg. These samples were immersed for five hours in 1000 mL of a solution of 2 mg/L methylene blue plus 10 percent methanol in water. (The methanol was added to eliminate any adsorption of methylene blue due to hydrocarbon/hydrocarbon attractions, so that only anionic adsorption occurs.) The stained fabrics were then removed from the solution and all excess solution wrung out of the fabrics. The stained fabrics were then extracted with four successive extractions of 50 mL 1% (volume/volume) phosphoric acid in methanol (20 minutes each at 40° C.) to remove all methylene blue dye. All extractions for each sample were combined in a 200 mL volumetric flask. After the final extractions were added, all flasks were cooled to room temperature and taken to the 200 mL mark by adding the extraction solvent. The amount of dye was measured by visible spectrometry along with standard solutions of methylene blue dye in the same solvent. The solution absorbances at wave number 653 cm-1 were used to calculate the anionic charge per wiper weight. The surface charge is calculated as shown in the footnote to Table II below with reference to Examples 1-3.

In the following examples, samples were made substantially in accordance with the procedure described above.

### EXAMPLE 1

Fluff grade pulps (northern softwood sulphite and southern softwood kraft) in roll form are lap fed into hammermills/defiberizers so as to defiberize the roll pulp into individual fibers. The individual cellulosic fibers are then transported via air in transport ducts to the forming heads or distributor units. The forming heads act as sifters to keep the fibers well dispersed until the suction air/vacuum under the forming head draws the individual cellulosic fibers onto a moving forming screen, thereby forming a substantially uniform fibrous web. The uniform fibrous web is then passed through a compaction (heated steel to rubber roll nip section) station to give the web some integrity and control the bulk/thickness of the web. Humidification is important to the web also to provide some web integrity and control bulk/thickness. The web is then to be passed through an embossing station to impart an emboss, a pattern for functional characteristics touch, softness, and aesthetics.

Polymer binder (ethylene vinyl acetate or EVA) containing sodium dioctyl sulfosuccinate as an anionic surfactant is then applied onto one side of the web and run through a flatbed through air dryer to drive off the water in the binder and to impart some strength to the web. The same binder/surfactant is then applied on the reverse side of the web, and similarly dried (drive off the water) in a second flatbed through air dryer. The now dried web is run through a third through air dryer to crosslink/cure the EVA binder using as a catalyst NaHSO₄ or NH₄Cl added to the binder formulation to impart good dry strength and permanent wet strength.

The airlaid fabric or web exhibited a basis weight of 41 to 48 pounds/ream, a caliper of 100 to 120 mils/4 sheets, machine direction dry tensile strength of 2000 to 3000 grams/3 inches, cross-direction wet tensile of 700 to 1100 grams/3 inches, and absorbency rate between 2 and 4 seconds.

### EXAMPLE 2

A nonwoven fabric or web containing a binder with a non-ionic surfactant is made using the airlaid process as described in Example 1, except the binder and surfactant used are non-ionic so as not to interfere with the cationic functional agent in the liquid load phase when converted into a moist wipe. The non-ionic binder is also an EVA, and the non-ionic surfactant is TDA-8 tridecyl alcohol ethoxylate from BASF. This fabric is embossed with the Quilted Northern® Double Hearts pattern.

The airlaid fabric exhibited a basis weight of 41 to 48 pounds/ream, caliper of 100 to 120 mils/4 sheets, machine direction dry tensile strength of 2000 to 3000 grams/3 inches, cross-direction wet tensile of 700 to 1100 grams/3 inches, and absorbency rate between 2 and 4 seconds. The airlaid fabric exhibited a surface anionic charge of 1.19 milli-equivalents/Kg as measured by the method described above.

### EXAMPLE 3

A nonwoven airlaid fabric is made containing a binder with non-ionic surfactant plus 0.33 wt. % active Reputex-20® poly(hexamethylene biguanide) cationic polymer to further reduce the surface anionic charge. In this example, the process is the same as Examples 1 and 2, except the poly(hexamethylene biguanide) is added to the same non-ionic binder/non-ionic surfactant as in Example 2.

The airlaid fabric exhibited a basis weight of 41 to 48 pounds/ream, caliper of 100 to 120 mils/4 sheets, machine direction dry tensile strength of 2000 to 3000 grams/3 inches, cross-direction wet tensile of 700 to 1100 grams/3 inches, an absorbency rate between 2 and 4 seconds, and a surface anionic charge of 1.11 milli-equivalents/Kg.

For each of the preceding Examples 1-3, and the calculated anionic surface charge, as well as the absorbance of the retained methyl blue, are set forth in Table II below.

TABLE II
Measurement of Anionic Surface Charge

| | | | | Calculated |
|---|---|---|---|---|
| | | Sample | Solution | Anionic |
| Example | | Weight | Absorbance | Charge* |
| No. | Binder Contains | (g) | (653/cm) | (meq/Kg) |
| 1 | Anionic Surfactants | 0.4547 | 0.427 | 1.80 |
| 2 | Non-ionic Surfactants | 0.5710 | 0.354 | 1.19 |
| 3 | Non-ionic Surfactants | 0.9861 | 0.573 | 1.11 |
| | +0.33% Reputex-20 | | | |

*The maximum absorbance of a 2.0 mg/L solution of methylene blue in
1% phosphoric acid in methanol is 0.558 absorbance. The molecular
weight of methylene blue trihydrate is 373.85 amu. These values were
used to calculate the listed surface charge values. Please note that
meq/Kg equals milli-equivalents anionic surface charge per kilogram of
dry wiper weight. The calculations were completed as follows:
Anionic surface charge in
$meq \text{/} Kg = abs . \times \frac{2.0 mg \text{/} L}{0.555 abs} \times \frac{1000 g \text{/} Kg}{373.85 meq \text{/} mg} \times \frac{0.20 L}{Wt ( g )}$

It will be observed that the airlaid webs of Examples 1, 2 and 3 listed in Table II are made with cellulose plus a polymer binder. The airlaid fabric of Example 1 exhibited a surface anionic charge of 1.80 milli-equivalents/Kg as measured by the method described above, which is too high resulting in an inadequate amount of cationic functional agent deliverable to a surface. The web of Example 2 has a lower anionic surface charge than the web of Example 1 due to the replacement of the anionic surfactant used in Example 1 by non-ionic surfactant. The web of Example 3 has a lower charge than that of Example 2 due to the addition of Reputex-20® to the binder. As shown in Table II, the fabric wipe of Example 2 has only about 66 percent of the surface anionic charge that is present in the fabric wipe of Example 1, and the fabric wipe of Example 3 has only about 62 percent of the surface anionic charge that is present in the fabric wipe of Example 1. As stated herein and illustrated in the examples, for purposes of our invention, the web should have an anionic surface charge not greater than about 1.2 meq/Kg.

In the following Examples 4-8, it is shown how anionic surface charge affects adsorption of a functional cationic additive carried in the imbuement.

These Examples 4, 5, 6, 7, and 8 were made using the three airlaid fabrics of Examples 1, 2, and 3. That is, airlaid webs made in accordance with Example 1 were tested for each of the Examples 4, 5, 6, 7, and 8; and the webs of Examples of 2 and 3 were likewise tested. All these webs were placed in solutions containing a functional cationic additive, as shown in Table III, below. For these examples, five different functional cationic additives were evaluated. The following examples were prepared and analyzed to show that reducing the anionic surface charge of the fabric used for a wet wipe allows more of a functional cationic additive to remain in the water-based imbuement, while less of the cationic additive is adsorbed by the wiper fabric.

The cationic additives were chosen to provide a range of alkyl (hydrocarbon) chains and/or aromatic rings on a quaternary ammonium cation. This includes examples from all classes of ammonium cations that are known additives. Quaternary ammonium compounds with 3 or 4 alkyl chains (of 10 or more carbons) are not very water-soluble and, therefore, are not good candidates for use as cationic solution additives.

In order to determine how much functional cationic additive remains in solution, the test wipes were prepared and analyzed as described below.

For all of the examples, each test tub was sealed with masking tape and shaken to distribute the test solution as uniformly as possible. The tubs were stored at room temperature for at least 5 days to allow the solution to achieve equilibrium with the fabric wipes. (This storage also imitates a minimum time expected from manufacture of a wet wipe product before purchase by a consumer.) The imbuement was then wrung out of the fabric and collected. A portion of each imbuement was diluted, filtered, and analyzed by ion chromatography to quantify the solution concentration of each test cationic additive (a Dionex® DX-600 ion chromatograph with a conductivity detector). A 4.6×150 mm Zirchrom®-PBD column (35° C.) was used with 1.0 mL/min 5 mM methanesulfonic acid in 50/50 acetonitrile/water. A CSRS-Ultra® suppressor (Dionex Corp.) was used at 50 mA current with 8 mL/min water flow through the regenerate side of the suppressor. Chromatograms were processed with a Waters® Millennium-32® data system. The benzethonium chloride was analyzed in the same manner except with a 40/60 acetonitrile/water blend. The imidazolinium softener (Varisoft® 3690) was analyzed in the same manner except with a 70/30 acetonitrile/water blend and using ultraviolet absorbance detection at 235 nm.

### EXAMPLE 4

A stack of each airlaid fabric (examples 1, 2, and 3, each cut to 9 cm by 14 cm sheets) weighing 25.0-grams was placed in a polyethylene plastic tub. A 75.0-gram portion of 0.118 weight % cetyl trimethyl ammonium bromide in 95/5 (volume/volume) water/ethanol was poured on top of the dry airlaid fabric for each of the three grades. Each tub was sealed, shaken, stored, and analyzed as discussed above.

### EXAMPLE 5

A stack of each airlaid fabric (Examples 1, 2, and 3, each cut to 9 cm by 14 cm sheets) weighing 25.0-grams was placed in a polyethylene plastic tub. A 75.0-gram portion of 0.115 weight % benzalkonium chloride in water was poured on top of the dry airlaid fabric for each of the three grades. Each tub was sealed, shaken, stored, and analyzed as discussed above.

### EXAMPLE 6

A stack of each airlaid fabric (Examples 1, 2, and 3, each cut to 9 cm by 14 cm sheets) weighing 25.0-grams was placed in a polyethylene plastic tub. A 75.0-gram portion of 0.131 weight % didecyl dimethyl ammonium chloride in 95/5 (volume/volume) water/ethanol was poured on top of the dry airlaid fabric for each of the three grades. Each tub was sealed, shaken, stored, and analyzed as discussed above.

### EXAMPLE 7

A stack of each airlaid fabric (Examples 1, 2, and 3, each cut to 9 cm by 14 cm sheets) weighing 25.0-grams was placed in a polyethylene plastic tub. A 75.0-gram portion of 0.144 weight % benzethonium chloride in water was poured on top of the dry airlaid fabric for each of the three grades. Each tub was sealed, shaken, stored, and analyzed as discussed above.

### EXAMPLE 8

A stack of each airlaid fabric (Examples 1, 2, and 3, each cut to 9 cm by 14 cm sheets) weighing 25.0-grams was placed in a polyethylene plastic tub. A 75.0-gram portion of 0.226% dioleyl imidazolinium methylsulfate (Varisoft® 3690 from Witco Chemical Corporation) in 90/10 (volume/volume) water/ethanol was poured on top of the dry airlaid fabric for each of the three grades. Each tub was sealed, shaken, stored, and analyzed as discussed above.

The results are shown in the following Table III.

TABLE III
Relative Ratio of the Initial Concentration that Remains in Solution or is Adsorbed

| Cationic | | | Ratio Remaining in | Ratio Remaining | Ratio Remaining |
|---|---|---|---|---|---|
| Solution | Type of | Initial | Solution/Initial | in Solution/Initial | in Solution/Initial |
| Additive | Quaternary | Weight % | (Adsorbed/Initial) | (Adsorbed/Initial) | (Adsorbed/Initial) |
| (Example No.) | Ammonium | Conc. | Using Example 1 | Using Example 2 | Using Example 3 |
| (4) | R—N⁺—(CH₃)₃ | 0.118 | 0.103 (0.897) | 0.186 (814) | 0.220 (780) |
| Cetyl trimethyl | | | | | |
| ammonium | | | | | |
| bromide | | | | | |
| (5) | R—N⁺—(CH₃)₂\ | 0.115 | 0.103 (0.897) | 0.250 (0.750) | 0.273 (0.727) |
| Benzalkonium | Benzyl | | | | |
| chloride | | | | | |
| (6) | R₂—N⁺—(CH₃)₂ | 0.131 | 0.057 (0.943) | 0.099 (0.901) | 0.110 (0.890) |
| Didecyl | | | | | |
| dimethyl | | | | | |
| ammonium | | | | | |
| chloride | | | | | |
| (7) | Special, | 0.144 | 0.036 (0.964) | 0.137 (0.863) | 0.176 (0.824) |
| Benzethonium | with 2 | | | | |
| Chloride | aromatic | | | | |
| | rings | | | | |
| (8) | R₂-Im⁺- | 0.226 | 0.123 (0.877) | 0.659 (0.341) | 0.606 (0.394) |
| Dioleyl | CH₃ | | | | |
| imidazolinium | (Varisoft ® | | | | |
| methylsulfate | 3690) | | | | |

The results In Table III show the applicable range of cationic functional additives normally used in water-based solutions. For example, in Table III where all percentages are by weight, the ratio of percent cetyl trimethyl ammonium bromide remaining in solution divided by the initial 0.118% cetyl trimethyl ammonium bromide is 0.103 after contact with the airlaid fabric of Example 1; similarly 0.186 after contact with the fabric of Example 2; and 0.220 after contact with the fabric of Example 3. The results in Table III clearly show that reducing the anionic surface charge of the wipes reduces the adsorption of the cationic functional additive by the wipe. Therefore, more of the cationic functional additive remains in the imbuement. The concentration in Example 6 is 0.115% benzalkonium chloride. This weight percent is the midpoint of a 0.10% to 0.13% range recommended by the United States Food and Drug Administration as a potential future level for skin contact wipes. The concentrations in the other listed examples were chosen to match the same molar concentration as the 0.115% benzalkonium chloride solution (3.22 millimolar or millimoles per liter). Since these cationic agents all have one cationic charge site per molecule, the concentration for these examples is 3.22 milli-equivalents per liter.

### EXAMPLE 9

Example 9 shows that blending a polar co-solvent with water does not change the effect that reducing anionic surface charge reduces adsorption of a functional cationic solution additive. The example was made using the three airlaid fabrics of Examples 1, 2, and 3. The purpose of this Example 9 was to demonstrate that replacing some of the water with a co-solvent does not change the results shown in Table III. A stack of each airlaid grade (cut to 9 cm by 14 cm) weighing 25.0-grams was placed in a polyethylene plastic tub. A 75.0-gram portion of 0.115 weight % benzalkonium chloride in 80/20 (volume/volume) water/ethanol was poured on top of the dry airlaid fabric for each of the three grades. Each tub was sealed with masking tape and shaken to distribute the test solution as uniformly as possible. The tubs were stored at room temperature for 18 days to allow the solution to achieve equilibrium with the fabric wipes. The lotion was then wrung out of the fabric and collected. A portion of each lotion was diluted, filtered, and analyzed by ion chromatography to quantify the solution concentration of each test cationic additive. The results are listed in Table IV. The ratio of benzalkonium chloride remaining in solution is nearly identical comparing the 100 percent water data to the 80/20 water/ethanol data.

TABLE IV
Relative Ratio of the Initial Concentration that Remains in Solution or is Adsorbed,
Comparing 100% Water Imbuement to 80% Water/20% Ethanol Imbuement

| | Volume % | Ratio Remaining in | Ratio Remaining in | Ratio Remaining in |
|---|---|---|---|---|
| Cationic Solution | Water/ | Solution/Initial | Solution/Initial | Solution/Initial |
| Additive | Volume % | (Adsorbed/Initial) | (Adsorbed/Initial) | (Adsorbed/Initial) |
| (Example No.) | Ethanol | Using Example 1 | Using Example 2 | Using Example 3 |
| (5) | 100/0 | 0.103 (0.897) | 0.250 (0.750) | 0.273 (0.727) |
| Benzalkonium | | | | |
| chloride | | | | |
| (0.115%) | | | | |
| (9) | 80/20 | 0.101 (0.899) | 0.214 (0.786) | 0.262 (0.738) |
| Benzalkonium | | | | |
| chloride | | | | |
| (0.115%) | | | | |

The data in Table IV confirm that the addition of up to 20 volume percent of a polar co-solvent to water does not change the benefits of this invention. Other polar co-solvents which would show data similar to ethanol include, but are not limited to, propylene glycol, poly(ethylene glycol), glycerin, and isopropanol.

### EXAMPLES 10 AND 11

Two commercial grade moist wipes were made using the two airlaid fabrics of Examples 1 and 2, and having loading of a cationic functional agent as shown in Table V, then tested for antimicrobial efficacy using the Zone of Inhibition Test. Each fabric was placed in a commercially prepared imbuement containing benzalkonium chloride as the functional cationic additive (an antimicrobial agent). The solution formulation is shown in Table V. The wipe of Example 10 was found to have lower antimicrobial efficacy than the moist wipes of Example 11, as measured by the Zone of Inhibition Test against six test microbes (Table VII).

Thus, Example 10 was prepared by the addition of 165 grams of the imbuement formulation listed in Table V, below, to 73 grams (50 wipes) of airlaid fabric of Example 1. The fabric wipes were wetted with imbuement, then interfolded, cut to final size, and stacked in sealed polyethylene plastic tubs. The data for Example 10 is the average of three prototype moist wipe production runs, each made from a separate roll of airlaid fabric and a separate batch of imbuement. The wipes were removed from the tubs after six weeks of storage at room temperature (20° C.). The lotion was squeezed out of the wipes and analyzed by ion chromatography to quantify the amount of benzalkonium chloride remaining in solution in the lotion. The results of these tests (Table VI, below) show that the average ratio of benzalkonium chloride remaining in solution in the imbuement is only 0.048 of the initial concentration. The initial benzalkonium chloride concentration in the imbuement is 0.115%. The average concentration remaining in the imbuement after six weeks was 0.0055%. Therefore, only 0.048 times the initial amount remained in the imbuement.

For Example 11, the wipes were prepared by the addition of 165 grams of the imbuement formulation listed in Table V, below, to 73 grams (50 wipes) of the airlaid fabric of Example 2. The fabric wipes were wetted with the imbuement, then interfolded, cut to final size, and stacked in sealed polyethylene plastic tubs. These tubs were then stored for about three weeks at room temperature. After three weeks, the imbuement was squeezed from three samples and analyzed by ion chromatography to quantify the benzalkonium chloride in each. The data for Example 11 listed in Table V are the average of four wipe production runs. The Table shows that 0.155 times the initial benzalkonium chloride concentration remained in solution compared to only 0.048 times the highly anionic wipes (Example 11). This difference demonstrates the effectiveness of a low cationic surface charge with commercial wipe imbuement formulations.

TABLE V
Lotion Formulation Containing 0.115% Benzalkonium Chloride

| | Weight % |
|---|---|
| Ingredient - Chemical Type | Active in Water |
| Methylchloroisothiazoline and Methylisothiazoline | Proprietary |
| | (<1%) |
| Disodium Cocoamphodiacetate | Proprietary |
| | (<1%) |
| Disodium ethylene diamine tetraacetate (EDTA) | Proprietary |
| | (<1%) |
| Natural Aloe Plant Extract | Proprietary |
| | (<1%) |
| Fragrance and Vitamin E | Proprietary |
| | (<1%) |
| Benzalkonium Chloride | 0.115 |

TABLE VI
Relative Ratio of the Initial Concentration that Remains in Solution
or is Adsorbed, Wipes Made with the Lotion Formulation of Table V

| Example | Weight % Benzalkonium | Ratio Remaining in Solution/ |
|---|---|---|
| Number | Chloride in Imbuement | Initial (Adsorbed/Initial) |
| 10 | 0.115 | 0.048 (0.952) |
| 11 | 0.115 | 0.155 (0.845) |

All test results are the average of testing three batches of sample moist wipes. Using this test method, disks cut from Example 10 and 11 all produced a zone of inhibition at least equal to the size of the test disk. Therefore, all of these examples killed the test microbes when benzalkonium chloride was at the measured concentration in solution in the lotion (Table V). The difference (Example 10 versus Example 11) is when comparing the area around the circular piece of test wet wipe. As the benzalkonium chloride (from the imbuement) diffuses away from the test disk, the concentration of benzalkonium chloride decreases with increasing distance from the test disk. Each test microbe has a different minimum inhibitory concentration (MIC) for benzalkonium chloride to effectively kill that microbe. Therefore, if the concentration of benzalkonium chloride is above the MIC, it is observed as a visible zone where the growth of that test microbe has been inhibited. For this reason, some test microbes show no additional zone around the disk (code 0 in Table V), some show a partial zone around the disk (code 1), some show a small inhibition zone (code 2), while other test microbes show a larger inhibition zone (code 3). Therefore, comparisons among example wet wipes can only be made while comparing the same test microbe.

When comparing results using the same microbe, the test does measure relative effectiveness of the example wet wipes. The results set forth in Table VI below show that, with four of the five test microbes, the benzalkonium chloride (from the imbuement) diffusing from the test wipes for Example 10 is not as effective as the benzalkonium chloride diffusing from Example 11. With the Staphylococcus aureus test microbe, the comparison shows the same zone of inhibition for Examples 10 and 11. Therefore, the imbuement from Example 10 appears to be as effective or more effective as an antimicrobial than the imbuement from Example 11. The bigger zones of inhibition for Example 11 compared to Example 10 are likely due to the soluble concentration of 0.0178% benzalkonium chloride (0.155.times the initial 0.115% benzalkonium chloride) in Example 11 compared to 0.0055% benzalkonium chloride (0.048 times the initial 0.115%) in Example 11. Starting with a higher benzalkonium chloride concentration would lead to a greater distance from the sample disk before the benzalkonium chloride concentration would be diluted to lower than the minimum inhibitory concentration (MIC).

TABLE VII
Antimicrobial Efficacy, Zone of Inhibition Results for Examples 8 and 9
(Measured Zones For Each Test Microbe - No Zone Indicates
Lowest Efficacy)

| | Inhibition Zone For | Inhibition Zone For |
|---|---|---|
| Test Microbe Name | Example 11 | Example 12 |
| Staphylococcus aureus | 3 | 3 |
| E. coli | 1 | 2 |
| Salmonella sps | 0 | 1 |
| Serratia marcescens | 1 | 2 |
| Candida albicans | 2 | 3 |

The numbers were listed in the table to make comparisons easier. The code for the numbers is 0 equals no inhibition zone in the area around the test circle (disk), 1 equals a partial inhibition zone, 2 equals a small inhibition zone, 3 equals a large inhibition zone.

Tests were conducted to determine or show that increasing the concentration of the cationic agent can overwhelm the surface charge. The present invention relies on the significance of reducing the anionic surface charge of the wipe so that less cationic agent can be added to the imbuement. If enough cationic agent is added to the imbuement, the anionic surface charge becomes irrelevant. However, somewhere between these extremes is a level of cationic agent that will increase the level remaining in solution enough to be functional. In order to determine the level at which that advantages decreases, Examples 12 through 16 were prepared by adding benzalkonium chloride solutions in the same manner as Example 5 to the dry wipes of Examples 1 and 2. After 5 days to equilibrate, the imbuement was squeezed from each sample. Benzalkonium chloride concentrations were determined in the imbuements using the ion chromatography method discussed above. The data are listed in Table VIII.

TABLE VIII
Benzalkonium Chloride in Water Squeezed from Wipes

| | | | Ratio | | Ratio | |
|---|---|---|---|---|---|---|
| | | | remaining | Weight % | remaining | Weight % |
| | Initial | Milli- | in solution/ | Benzalkonium | in solution/ | Benzalkonium |
| | Weight % | equivalents | initial | Chloride in | initial | Chloride in |
| Example | Conc. In | per liter in | Example | Solution, With | Example 2 | Solution, With |
| Number | Water | Water | 1 Wipes | Ex. 1 Wipes | Wipes | Ex. 2 Wipes |
| 5 | 0.115 | 3.2 | 0.103 | 0.012 | 0.250 | 0.029 |
| 12 | 0.143 | 4.0 | 0.090 | 0.013 | 0.308 | 0.044 |
| 13 | 0.178 | 5.0 | 0.119 | 0.021 | 0.323 | 0.058 |
| 14 | 0.214 | 6.0 | 0.132 | 0.028 | 0.336 | 0.072 |
| 15 | 0.285 | 8.0 | 0.299 | 0.085 | 0.388 | 0.111 |
| 16 | 0.571 | 16.0 | 0.587 | 0.335 | 0.568 | 0.324 |

It will observed from the Table VIII, that as the concentration of benzalkonium chloride is increased, a higher weight percent stays in solution (columns 5 and 7). This is due to both the higher initial weight percent (column 2) and the higher percentage of the initial concentration that remains in solution (columns 4 and 6). At 16 milli-equivalents per liter there is so much cationic charge that the anionic surface charge of the fabric does not matter. (The approximately 43 percent adsorption must be due to some other phenomenon.) With regards to the two values in bold numbers, the 0.029% concentration of benzalkonium chloride remaining in solution was shown to be sufficient for antibacterial efficacy. Note that, at 6 milli-equivalents per liter (0.214%) benzalkonium chloride, the concentration of benzalkonium chloride in solution with the Example 1 airlaid has reached essentially the same level as the benzalkonium chloride shown to have antibacterial efficacy (0.028% compared to 0.029%). Therefore, anything above about 6 milli-equivalents per liter is more concentrated than levels that receive significant advantages from reducing the anionic surface charge of the wipes as discussed in this patent.

It will be observed that the moist wipe of our invention provides for several advantages, including the fact that in order to provide a moist wipe capable of delivering an effective amount of functional agent, there is no need for excessive loadings of the medium containing the agent. Further, it should be understood that the foregoing detailed description has been given for clearness of understanding only, and no unnecessary limitations should be understood therefrom as modifications will be obvious to those skilled in the art.

What is claimed is:

1. A moist wipe comprising:
a bonded non-woven web containing cellulosic fibers and binder that is substantially aldehyde free, wherein the non-woven web has a substantially neutral surface charge; and
about one to three times a dry weight of the non-woven web of an aqueous imbuement carrying a cationic functional agent at a concentration of about 6 milli-equivalents per liter or less, the cationic functional agent partially adsorbed by the non-woven web.

2. A moist wipe according to claim 1, wherein the weight of the imbuement is about two to three times the dry weight of the web.

3. A moist wipe according to claim 1, wherein the ratio of the concentration of the cationic functional agent remaining in solution divided by the initial cationic functional agent concentration is at least 0.15.

4. A moist wipe according to claim 1, wherein the cationic functional agent is a monomeric cationic functional agent.

5. A moist wipe according to claim 1, wherein the functional agent is an antimicrobial agent.

6. A moist wipe according to claim 5, wherein the functional agent is an antimicrobial agent selected from the group consisting of benzalkonium chloride, benzethonium chloride, and mixtures thereof.

7. A moist wipe according to claim 6, wherein the antimicrobial agent is benzalkonium chloride.

8. A moist wipe according to claim 6, wherein the antimicrobial agent is benzethonium chloride.

9. A moist wipe according to claim 1, wherein the web is airlaid and having a basis weight of about 30 to 60 pounds per square foot, and a cross direction wet tensile cured of at least about 300 grams per three inches.

10. A moist wipe comprising: a bonded non-woven web consisting essentially of dry laid cellulosic fibers bonded together with a binder comprising a combination of a polymer and a surfactant chosen from the group consisting of non-ionic surfactants and cationic surfactants, the web having a basis weight of about 90 to about 140 lbs. per 300-sq. ft. ream, a caliper of about 120 to about 160 mils per 8 sheets, a CD wet tensile strength of at least about 300 g/3″, an MD wet tensile strength of at least about 700 g/3″ and having an anionic surface charge of not greater than about 1.2 meq per kilogram of dry web, and about one to three times the dry weight of the web of an aqueous imbuement carrying a cationic functional agent at a concentration of about 6 milli-equivalents per liter or less, the cationic functional agent partially adsorbed by the web and chosen from the group consisting of benzalkonium chloride, benzethonium chloride, and mixtures thereof.
